(19) United States
(12) Patent Application Publication
(10) Pub. No.: US 2017/0305575 A1
(43) Pub. Date: Oct. 26, 2017

(54) PAYLOAD FUNNEL

(71) Applicant: Flytrex Aviation Ltd., Tel Aviv (IL)

(72) Inventors: Yariv BASH, Tel Aviv (IL); Amit REGEV, Tel Aviv (IL)

(73) Assignee: Flytrex Aviation Ltd., Tel Aviv (IL)

(21) Appl. No.: 15/495,254

(22) Filed: Apr. 24, 2017

Related U.S. Application Data
(60) Provisional application No. 62/326,790, filed on Apr. 24, 2016.

(51) Int. Cl. B64F 1/32; B64C 39/02; B64D 1/08

(52) U.S. Cl. CPC B64F 1/32; B64D 1/08; B64C 39/024; B64C 2201/128

(57) ABSTRACT

A payload funnel for receiving a payload, comprising: a base member including a top surface; a top member defining an aperture for receiving the payload; a support having a bottom portion and a top portion, wherein the bottom portion of the support is connected to the base member, wherein the top portion is connected to the top member, the support defining an interior cavity, wherein the payload received by the payload funnel passes through the aperture into the interior cavity and onto the top surface of the base member, the support further defining an opening for removing the payload from the interior cavity.

### CROSS-REFERENCE TO RELATED APPLICATIONS

This application claims the benefit of U.S. Provisional Application No. 62/326,790 filed on Apr. 24, 2016, the contents of which are hereby incorporated by reference.

### TECHNICAL FIELD

The present disclosure relates generally to payload receiving systems, and more particularly to aerial payload receiving systems.

### BACKGROUND

Unmanned aerial vehicles, also commonly known as drones, such as those capable of hovering, have proven useful for moving payloads. As a result, many companies have begun to use unmanned aerial vehicles to deliver items such as packages, mail, and the like. With the advent and rapid adoption of so-called “drone delivery” services, it has become increasingly important to safely deliver such payloads.

Existing solutions for payload delivery face issues in ensuring that the payload and its contents remain undamaged and intact. Other challenges relate to concerns for safety of humans and animals coming near an unmanned vehicle, as unmanned vehicles may move rapidly, may be heavy, and/or may include potentially hazardous moving parts.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a payload funnel for receiving a payload, comprising: a base member including a top surface; a top member defining an aperture for receiving the payload; a support having a bottom portion and a top portion, wherein the bottom portion of the support is connected to the base member, wherein the top portion is connected to the top member, the support defining an interior cavity, wherein the payload received by the payload funnel passes through the aperture into the interior cavity and onto the top surface of the base member, the support further defining an opening for removing the payload from the interior cavity.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a payload funnel according to an embodiment.

FIG. 2 is a schematic diagram illustrating a base structure of a payload funnel according to an embodiment.

FIG. 3 is a schematic diagram of a base structure having a pneumatic shutter according to an embodiment.

FIG. 4 is a schematic diagram of a shutter control circuit according to an embodiment.

FIG. 5 is a flowchart illustrating a method for receiving a payload using a payload funnel according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a payload funnel and methods for receiving payloads via a payload funnel. In an embodiment, the payload funnel includes a base member, a top member, and a support. The base member has a base circumradius and a base apothem. The top member is adapted to receive a payload (e.g., a package), and has a top member circumradius and a top member apothem. The support has a top portion, a bottom portion, and an interior cavity defined between the top portion and the bottom portion.

The top portion of the support is connected to the top member and the bottom portion of the support is connected to the base member such that the support extends from the base member to the top member. A payload received through the top member passes into the interior cavity of the support and is deposited on the base member. The support may further define an opening allowing for removal of a payload deposited therein. The opening may be further covered by a shutter, which may be controlled via a shutter controller, thereby allowing for secure removal of a payload deposited in the payload funnel.

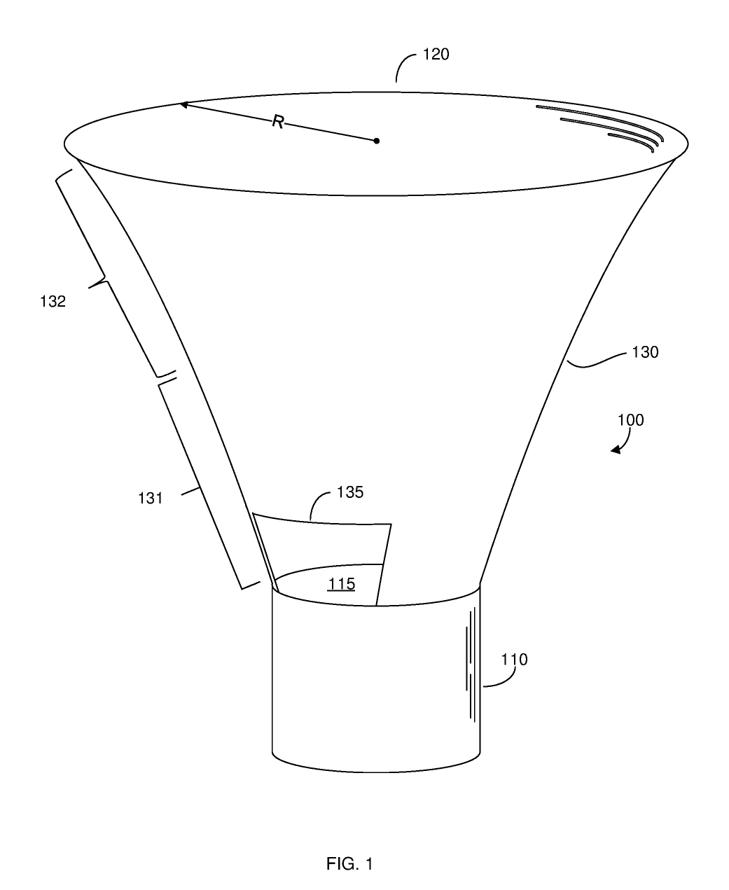

FIG. 1 shows an example schematic diagram of a payload funnel 100 according to an embodiment. The payload funnel 100 includes a base member 110, a top member 120, and a support 130. The base member 110 has a top surface 115. In the example schematic diagram shown in FIG. 1, the support 130 has a bottom portion 131, a top portion 132, and an opening 135. The bottom portion 131 is connected to the top surface 115 of the base member 110, and the top portion 132 is connected to the top member 120. In an example, implementation, the base member 110 may be located at the bottom of the funnel 100.

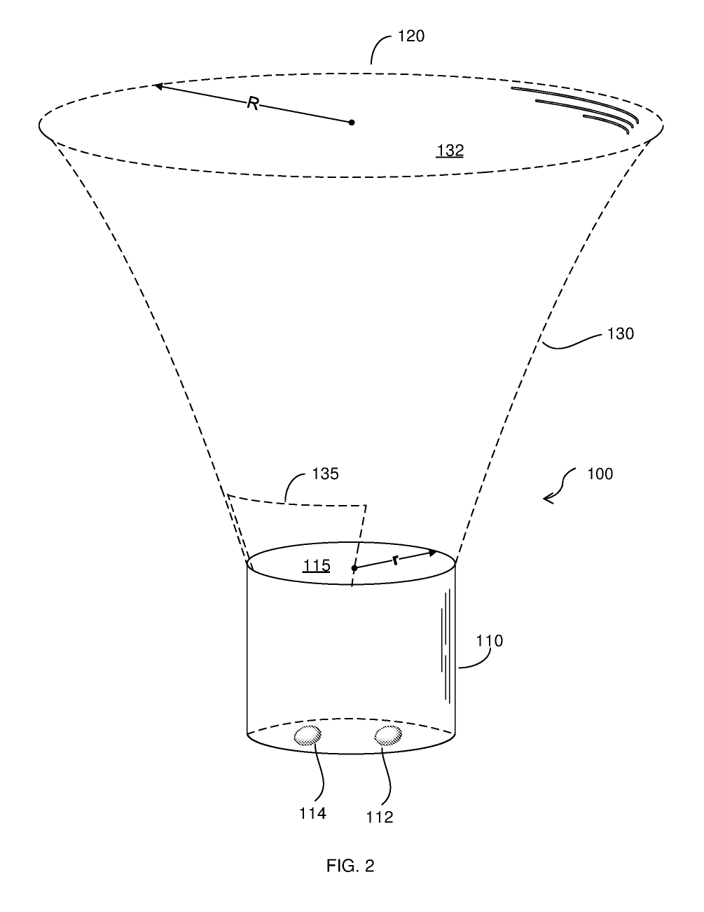

In an embodiment, the base member 110 has a base radius (r, shown in FIG. 2) and a base apothem. In a further embodiment, the top member 120 has a top member radius (R) and a top member apothem. In yet a further embodiment, the length of the base circumradius is less than the length of the top member apothem. It should be noted that, in embodiments in which the base member 110, the top member 120, or both, has a cross-sectional shape of, e.g., a polygon (rather than the circular cross-sections shown in FIG. 1), either or both radii may be circumradii, each circumradius having a length equal to the length of the radius of a circumscribed circle of the respective polygon. Accordingly, in some embodiments, the length of the base circumradius is less than the length of the top member apothem. In further embodiments where the base member 110, the top member 120, or both, has a polygonal cross-section, the respective apothem and circumradius of each member 110 or 120 may be approximately equal (i.e., as the number of sides of the polygonal cross-section increases, the values of the apothem and circumradius of the polygonal cross-section converge).

In an embodiment, the top member 120 is adapted to receive a payload (e.g., a package, mail, etc.). To this end, in an embodiment, the top member 120 defines an aperture, where the payload is received through the aperture. In some embodiments, the top member 120 allows an unmanned aerial vehicle (UAV, not shown) to hover at least partially through the top member 120 such that the UAV can at least partially hover in the support 130. In another embodiment, the top structure 120 is adapted to allow payloads to enter therethrough (i.e., payloads may be received from outside the funnel 100) while preventing exiting of payloads therethrough (i.e., payloads may not exit the funnel 100 once they have passed through the top member 120). To this end, in a further embodiment, the top structure 120 is defined by a topological boundary such as, but not limited to, a plurality of petals bending inward. In yet another embodiment, the top member 120 may be parallel or substantially parallel to the top surface 115 of the base member 110.

In an embodiment, the support 130 is connected to the base member 110 and to the top member 120. In a further embodiment, the support defines an interior cavity (132, FIG. 2). The support 130 is connected to the top member 120 such that payloads received via the aperture of the top member 120 pass through the aperture and into the interior cavity of the support 130. In another embodiment, the support 130 may taper from the top member 120 to the base member 110. In the example implementation shown in FIG. 1, a topological boundary of the support 130 is elliptical. It should be noted that other shapes for the topological boundary of the support 130 may be equally utilized without departing from the scope of the disclosed embodiments. As a non-limiting example, the support 130 may be shaped so as to collectively define a frustum shape with the base member 110 and the top member 120.

In yet another embodiment, the support 130 may be or may include a plurality of support members adapted to collectively support the top member 120. As a non-limiting example, the support 130 may be a plurality of rods having top and bottom ends, each of which is connected to the top member 120 at the top end and to the base member 110 at the bottom end. In another embodiment, the support 130 may be a wire mesh extending from the base member 110 to the top member 120.

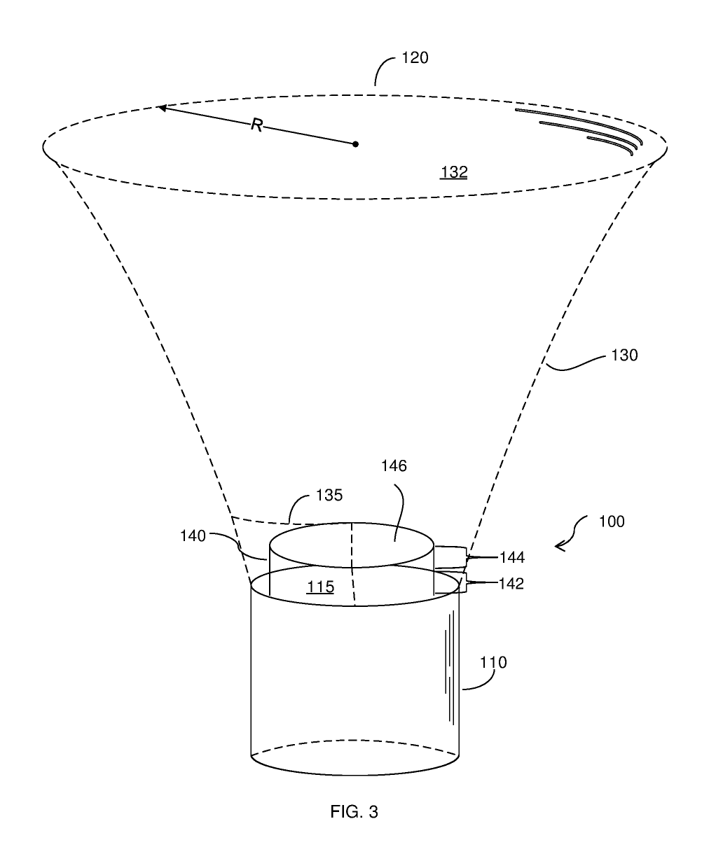

In an embodiment, the support 130 defines an opening 135 allowing for removal of a payload received via the top member 120. In a further embodiment, the support 130 includes a shutter (e.g., the shutter 140, FIG. 3) having an open state and a closed state, where the shutter covers the opening 135 when in the closed state and where the opening 135 is exposed when the shutter is in the open state. Consequently, in an embodiment, a payload deposited in the funnel 100 can only be retrieved when the shutter is in the open state. The shutter may be, but is not limited to, a hinged door, a plurality of flexible flaps, and the like.

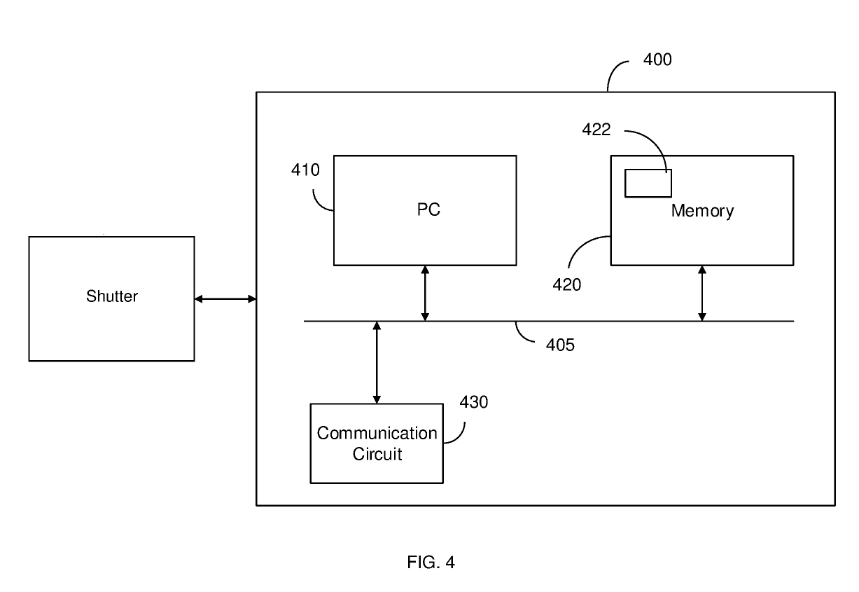

In an embodiment, the shutter may be controlled via a shutter controller (e.g., the shutter controller 400, FIG. 4). The shutter controller is configured to control the state of the shutter and, consequently, whether payloads can be retrieved from the funnel 100. The shutter controller may include a transceiver, which may be configured to communicate with a user device via, e.g., a direct channel, a wireless network (e.g., a mobile network), a radio-frequency signal, a photonic signal, and the like. The shutter may further be configured to lock such that, e.g., the shutter is only opened upon, e.g., receipt of an instruction from an authorized device (e.g., a user device, a server, etc.). To this end, in an embodiment, the shutter may include a lock (e.g., a bolt lock, not shown), where the lock may be operated via the shutter controller.

In an embodiment, the payload funnel 100 may further include a marker utilized to identify the payload funnel 100 such as, but not limited to, a barcode or other visual indicator. The marker may be identified, e.g., by a UAV via image processing in order to confirm that the UAV is the intended repository for a payload.

FIG. 2 is an example schematic diagram of the base member 110 according to an embodiment. The base member 110 has a top surface 115 adapted to support a payload received via the top member 120, FIG. 1, and deposited in an interior cavity 132 defined in the support 130.

In an embodiment, the base member 110 may be adapted to be affixed to a fixture or other permanent or semi-permanent structure such as, but not limited to, the ground, a phone booth, a mailbox, a mail deposit box, a building, and the like. To this end, in a further embodiment, the base member 110 includes or is connected to at least one affixing member. In the example implementation shown in FIG. 2, the base member 110 includes bolts 112 and 114.

In some embodiments, the base member 110 may be further connected to a cushion (not shown). The cushion absorbs at least a portion of the kinetic energy of payloads deposited in the payload funnel 100. The cushion may be or may include, foam, at least one spring, and the like.

FIG. 3 is an example schematic diagram of the payload funnel 100 including a shutter 140 according to an embodiment. In an example implementation, the shutter 140 may be a pneumatic shutter operated via pressure. In other example implementations, the shutter 140 may be a door (not shown) or other movable shutter having an open state where the shutter 140 does not block the opening 135 and a closed state where the shutter 140 blocks the opening 135. Further, the shutter 140 shown in FIG. 3 includes a bottom portion 142 and a top portion 144 having a top surface 146. The bottom portion 142 of the shutter 140 may be connected to the base member 110.

In an embodiment, the top portion 144 of the shutter 140 protrudes from the base member 110 when in a first lifted position (as shown in FIG. 3), which may correspond to an open state of the shutter 140 where the opening 135 is exposed. In a further embodiment, the shutter 140 may descend to a second depressed position (not shown) when depressed by the weight of a payload deposited in the funnel 100, which may correspond to a closed state of the shutter 140 where the opening 135 is unexposed. In the second depressed position, the shutter 140 may protrude less than in the first lifted position.

In an embodiment, the shutter 140 may change from the closed state to the open state upon receiving a state change instruction from a shutter controller (e.g., the shutter controller 400, FIG. 4), thereby allowing for retrieval of a payload deposited in the funnel 100 via the exposed opening 135.

In an embodiment, the shutter 140 may be tubular or arc-shaped. In a further embodiment, the radius of a cross-section of the shutter 140 may be less than or equal to the radius r of the cross-section of the base member 110. In another embodiment, the top portion 144 of the shutter 140 may be connected to a cushion for absorbing at least a portion of the kinetic energy of a payload deposited in the funnel 100. The cushion may be or may include at least one spring, foam, and the like.

It should be noted that the embodiments described herein with respect to FIGS. 1-3 are not limited to pneumatic shutters, and that other shutters may be equally utilized without departing from the scope of the disclosed embodiments. For example, the shutter 140 may be operated via a hydraulic mechanism.

FIG. 4 is an example schematic diagram of a shutter controller 400 according to an embodiment. The shutter controller 400 includes a processing circuitry 410 coupled to a memory 420, and a communication circuit 430. In an embodiment, the components of the shutter controller 400 may be communicatively connected via a bus 405. The shutter controller 400 is communicatively connected to a shutter (e.g., the shutter 140, FIG. 3).

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 420 may be volatile (e.g., RAM, etc.), non-volatile (e.g., ROM, flash memory, etc.), or a combination thereof.

In an embodiment, the memory 420 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 410 to perform the various processes described herein. Specifically, the instructions, when executed, cause the processing circuitry 410 to control opening and closing of a shutter, as discussed hereinabove. In a further embodiment, the instructions may be stored in a memory portion 422 of the memory 420.

The communication circuit 430 allows the shutter controller 400 to communicate with the shutter, with at least one controlling device (e.g., a user device or a server), at least one sensor (not shown), or a combination thereof, for purposes such as, but not limited to, controlling operation of the shutter, receiving sensor signals, receiving instructions for controlling the shutter, and the like.

In an embodiment, the shutter controller 400 is configured to receive instructions for opening or closing the shutter, and to open or close the shutter based on the received instructions. In a further embodiment, the shutter controller 400 may be configured to open the shutter for a limited period of time followed by closing the shutter.

In an embodiment, the shutter controller 400 is configured to receive sensor signals related to an interior cavity of a funnel (e.g., the interior cavity 132 of the funnel 100) and to determine, based on the received sensor signals, whether a payload is deposited in the funnel. The sensor signals may be received from sensors such as, but not limited to, pressure sensors, photonic sensors, and the like.

In an embodiment, the shutter controller 400 may further include a beacon (not shown) and be deployed in physical proximity to the shutter of a payload funnel. The beacon may be detectable by, e.g., an unmanned aerial vehicle, thereby ensuring that the payload is deposited in the correct payload funnel. The beacon may, for example, transmit an identifier to the unmanned aerial vehicle, where the identifier is utilized to confirm whether the funnel is the desired destination.

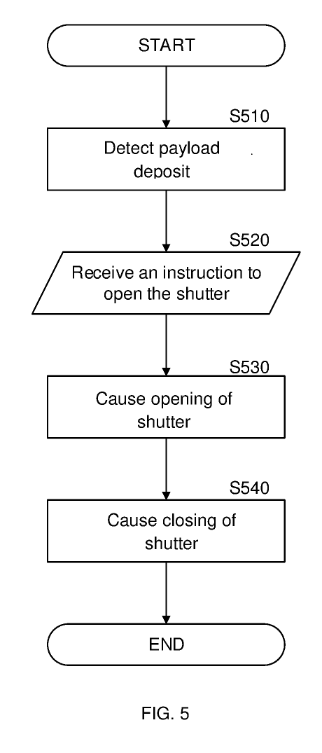

FIG. 5 is an example flowchart 500 illustrating a method for secured payload receipt according to an embodiment. In an embodiment, the method may be performed by the shutter controller 400 via the payload funnel 100 including the shutter 140, where the shutter 140 is controlled by the shutter controller 400. The shutter 140, when closed, prevents exposure of the opening 135 in the support 130 of the payload funnel 100.

At optional S510, upon detection of a payload deposited in a payload funnel, a shutter of the funnel is closed, thereby preventing access to an opening of the funnel. The payload may be detected based on sensor signals received from at least one sensor such as, but not limited to, a pressure sensor, a photonic sensor, and the like. As non-limiting examples, a payload may be detected when a pressure signal is above a predetermined threshold (i.e., representing that a payload has been placed on a pressure sensor in the funnel), when a photonic signal is below a predetermined threshold (i.e., representing that the payload or an unmanned aerial vehicle carrying the payload is at least partially inside the funnel), and the like.

In an embodiment, S510 further includes determining, upon detecting the payload, whether the shutter is closed, and closing the shutter if it is determined that the shutter is open.

At S520, an instruction to access the opening is received. The instruction may be received, e.g., via a communication circuit (e.g., the communication circuit 430 of the shutter controller 400), and may be received from a controlling device (e.g., a user device or a server) communicatively connected to the communication circuit. In an embodiment, S520 may include determining whether the instruction is received from an authorized device. In a further embodiment, the instruction may only be executed if the instruction is received from an authorized device. A list of authorized devices may be, e.g., stored locally in the shutter controller. To this end, S520 may further include receiving a device identifier and comparing the received device identifiers to identifiers of the list of authorized devices.

At S530, upon receiving an instruction to access the opening in the funnel, the shutter is caused to be opened.

At S540, the shutter is caused to be closed. In an embodiment, S540 may include checking whether the payload has been removed and, when it is determined that the payload has been removed, closing the shutter. The check may be based on, e.g., sensor signals related to an interior cavity of the funnel. In a further embodiment, when it is determined that the payload has not been removed, the shutter may be closed after, e.g., a predetermined period of time. In another embodiment, whether the payload has been removed may be checked a plurality of “N” times, where “N” is an integer having a value equal to or greater than 2. The checking may be performed at predetermined time intervals where, if it is not determined that the payload has been removed after the Nth check, the shutter may be closed.

It should be noted that the various embodiments disclosed herein are discussed with respect to a payload merely for simplicity purposes and without limitation on the disclosed embodiments. The disclosed funnel may be utilized to receive any objects such as, but not limited to, packages and envelopes. The objects received by the funnel may be deposited by, e.g., a drone, a mail carrier, a delivery chute, and the like. Accordingly, the funnel may generally be utilized to safely receive any object that is not too large to pass through the aperture in the top member.

The various embodiments disclosed herein related to receiving payloads and controlling payload funnels can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A payload funnel for receiving a payload, comprising:
a base member including a top surface;
a top member defining an aperture for receiving the payload;
a support having a bottom portion and a top portion, wherein the bottom portion of the support is connected to the base member, wherein the top portion is connected to the top member, the support defining an interior cavity, wherein the payload received by the payload funnel passes through the aperture into the interior cavity and onto the top surface of the base member, the support further defining an opening for removing the payload from the interior cavity.

2. The payload funnel of claim 1, further comprising:
a shutter affixed to the support, the shutter having an open state and a closed state, wherein the opening is exposed when the shutter is in the open state, wherein the opening is unexposed when the shutter is in the closed state.

3. The payload funnel of claim 2, wherein the shutter is a pneumatic shutter, wherein the shutter is in the closed state when the shutter is depressed.

4. The payload funnel of claim 2, further comprising:
a shutter controller, the shutter controller including:
a processing circuitry; and
a memory, the memory containing instructions that, when executed by the processing circuitry, configure the shutter controller to:
cause the shutter to open.

5. The payload funnel of claim 4, wherein the shutter controller is further configured to:
determine, based on at least one sensor signal, whether the payload is deposited in the payload funnel after the shutter is opened; and
cause the shutter to close, when it is determined that the payload is not deposited in the payload funnel after the shutter is opened.

6. The payload funnel of claim 5, wherein the shutter is caused to close after a predetermined period of time since the shutter is opened.

7. The payload funnel of claim 4, wherein the shutter controller is further configured to:
determine, based on at least one sensor signal, whether the payload is deposited in the payload funnel, wherein the shutter is caused to open when it is determined that the payload is deposited in the payload funnel.

8. The payload funnel of claim 4, the shutter controller further comprising a communication circuit, wherein the shutter controller is further configured to:
receive, via the communication circuit, an instruction to open the shutter, wherein the shutter is caused to be opened when the instruction to open the shutter is received.

9. The payload funnel of claim 1, the top surface of the base member having a base radius, the top member having a top member apothem, wherein the base radius is less than the top member apothem.

10. The payload funnel of claim 1, the top surface of the base member having a base circumradius, the top member having a top member apothem, wherein the base circumradius is less than the top member apothem.

11. The payload funnel of claim 1, wherein the base member further includes at least one affixing member.

12. The payload funnel of claim 1, wherein the support includes at least one rod, each rod having a top end and a bottom end, wherein the top end of each rod is connected to the top member, wherein the bottom end of each rod is connected to the based member.

13. The payload funnel of claim 1, wherein the support includes a wire mesh extending from the base member to the top member.

14. The payload funnel of claim 1, the top surface of the base member having a base circumradius and a base apothem, wherein the base circumradius and the base apothem are equal.

15. The payload funnel of claim 1, the top member having a top member circumradius and a top member apothem, wherein the top member circumradius and the top member apothem are equal.
